(19) United States
(12) Patent Application Publication
(10) Pub. No.: US 2007/0091905 A1
(43) Pub. Date: Apr. 26, 2007

(54) Telecommunication system gateway architecture and method

(76) Inventors: Eric Alan Henderson, Cupertino, CA (US); Scott Gulland, Roseville, CA (US); Yu-Lin Lu, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,169

(22) Filed: Oct. 25, 2005

(51) Int. Cl. H04L 12/56; H04L 12/28

(52) U.S. Cl. 370/401; 370/420

(57) ABSTRACT

A telecommunications system gateway architecture comprises at least one service logic module communicatively coupled to a plurality of mediation layer modules, each respective mediation layer module adapted to interface the at least one service logic module with a respective different network domain.

### BACKGROUND OF THE INVENTION

Parlay is a set of object-oriented application programming interfaces (APIs) configured to permit network operators to provide controlled access to network resources by parties outside the network, such outside parties generally referred to as third party service providers. Service applications of such service providers use the Parlay APIs to access and direct network resources to perform specific actions or fuinctions. However, because different types of telecommunications networks and/or different types of service applications desiring access and/or information relating to the telecommunications network, gateways to the telecommunications network need to be custom-configured and are not readily adaptable to changes and/or new applications or networks, thereby hindering scalable distributed solutions, performance bottleneck problems result.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a telecommunications gateway architecture system in accordance with the present invention.

### DETAILED DESCRIPTION OF THE DRAWINGS

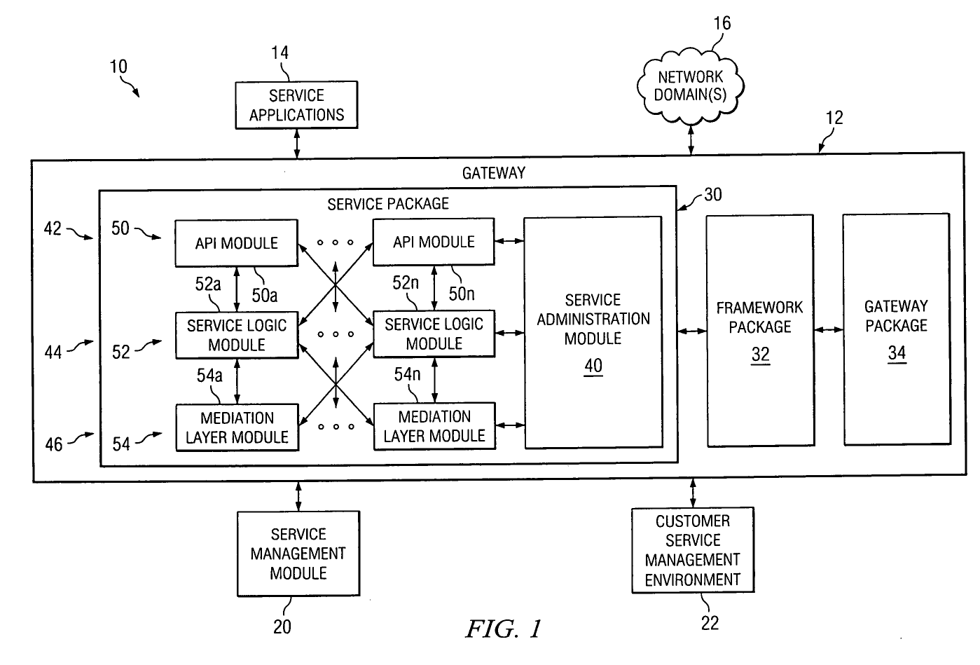

The preferred embodiments of the present invention and the advantages thereof are best understood by referring to FIG. 1 of the drawings, like numerals being used for like and corresponding parts of the various drawings.

FIG. 1 is a diagram illustrating an embodiment of a telecommunication system 10 in which a telecommunication gateway architecture 12 in accordance with the present invention is used to advantage. In the embodiment illustrated in FIG. 1, gateway architecture 12 is configured to interface third party service application(s) 14 with network domain(s) 16. Service applications 14 generally comprise a third party's backend service applications configured and/or otherwise adapted to access network(s) 16 services via gateway architecture 12. Network domain(s) 16 may comprise any type of communications network, wired or wireless, such as, but not limited to, a wide area network (WAN), local area network (LAN), a wireless local area network (WLAN), public land mobile network (PLMN), public switched telephone network (PSTN), and any type of Internet protocol(IP)-based networks.

In the embodiment illustrated in FIG. 1, system 10 also comprises a service management module 20 and a customer service management environment 22. Customer service management environment 22 comprises an interface adapted to enable information associated with customers (e.g., end-users and/or subscribers) of network(s) 16 to be communicated with architecture 12 and/or service application(s) 14. For example, customer service management environment 22 enables information such as, but not limited to, telephone numbers, account information, subscriber plans, and/or other network-related information associated with a customer and/or end-user of network(s) 16 to be communicated with architecture 12 and/or service application(s) 14. Service management module 20 comprises an interface to enable a third party service provider access to gateway architecture 12 to configure gateway architecture 12 to obtain desired information associated with network 16 services used by such customers and/or end-users (e.g., to configure gateway architecture 12 to collect particular types of information associated with services utilized by end-users).

In the embodiment illustrated in FIG. 1, gateway architecture 12 comprises a service package 30, a framework package 32 and a gateway package 34. Gateway package 34 comprises utilities and/or tools to provide a management interface to gateway architecture 12. Framework package 32 provides a framework for utilizing network 16 services such as, but not limited to, registration of a particular customer and/or end-user, authentication of such customers and/or end-users, and various other access control and/or security implementations. Service package 30 comprises hardware, software, or combination of hardware and software, to enable control, access to and/or obtain information associated with particular telecommunication services of network 16 associated with end-users such as, but not limited to, call control, session monitoring, billing control and authorization, and account management.

In the embodiment illustrated in FIG. 1, service package 30 comprises a service administration module 40 and three tiers 42, 44 and 46 for interfacing service application(s) 14 with network domain(s) 16. In the embodiment illustrated in FIG. 1, the first tier, indicated by 42, comprises application programming interface (API) module(s) 50, the second tier, indicated by 44, comprises service logic module(s) 52, and the third tier, indicated by 46, comprises mediation layer module(s) 54. API modules 50, service logic modules 52 and mediation layer modules 54 may comprise hardware, software, firmware, or a combination thereof. Service logic module(s) 52 provide desired telecommunication services to service application(s) 14 such as, but not limited to, call control, session monitoring, billing, and other services associated with a customer's or end-user's use of network domain(s) 16. API modules 50 provide an interface between service application(s)14 and service logic module(s) 52. Further, mediation layer module(s) 54 provide an interface between service logic module(s) 52 and network domain(s) 16.

In the embodiment illustrated in FIG. 1, service logic modules 52 are each communicatively coupled to one or more mediation layer modules 54 to facilitate interfacing of each particular service logic module 52 with different types of network domains 16. For example, in some embodiments of the present invention, each mediation layer module 54 is configured to provide an interface to a particular network domain 16. Thus, for example, in some embodiments of the present invention, a particular service logic module 52 is adapted to interface with at least two different types of network domains 16 via two different respective mediation layer modules 54. Further, in the embodiment illustrated in FIG. 1, service logic modules 52 are each communicatively coupled to one or more API modules 50 to facilitate interfacing of particular service logic modules 52 with one or more different service applications 14. For example, in some embodiments of the present invention, each API module 50 is configured to provide an interface to a particular service application 14. Thus, in some embodiments of the present invention, a particular service logic module 52 is adapted to interface with different service applications 14 via respective different API modules 50.

In the embodiment illustrated in FIG. 1, service package 30 comprises API modules 50a to 50n, service logic modules 52a to 52n, and mediation layer modules 54a to 54n, where “n” indicates any desired quantity of respective modules. API modules 50 are communicatively coupled to select service logic modules 52 to provide an interface between the selected service logic modules 52 and particular service applications 14. For example, in the embodiment illustrated in FIG. 1, service logic module 52a is communicatively coupled to API modules 50a and 50n. Further, in the embodiment illustrated in FIG. 1, service logic module 52n is communicatively coupled to API modules 50a and 50n. However, it should be understood that the mapping of service logic modules 52 to API modules 50 may be otherwise configured. Further, mediation layer modules 54 are communicatively coupled to select service logic modules 52 to provide an interface between the selected service logic modules 52 and particular network domains 16. For example, in the embodiment illustrated in FIG. 1, service logic module 52a is communicatively coupled to mediation layer modules 54a and 54n. Further, in the embodiment illustrated in FIG. 1, service logic module 52n is communicatively coupled to mediation layer modules 54a and 54n. However, it should be understood that the mapping of service logic modules 52 to mediation layer modules 54 may be otherwise configured.

Service administration module 40 is configured to enable communicative coupling of service logic modules 52 to respective API modules 50 and/or respective mediation layer modules 54. For example, in some embodiments of the present invention, service administration module 40 enables mapping of a particular service module 52 to a single mediation layer module 54 or a plurality of different mediation layer modules 54 such that each particular mediation layer module 54 interfaces the particular service logic module 52 to a respectively different network domain 16. Further, service administration module 40 enables mapping of a particular service logic module 52 to a single API module 50 or a plurality of different API modules 50 such that each API module 50 interfaces the particular service logic module 52 to a respectively different service application 14.

Thus, tier 42 of architecture 12 enables adaptability of architecture 12 to new and/or additional service applications 14 and/or modifications to existing service applications 14 without necessitating a change and/or redesign to a respective service logic module 52. For example, in some embodiments of the present invention, to support a new and/or additional service application 14 and/or a change to a particular service application 14, an API module 50 is provided and/or otherwise configured to interface with such service application 14. In some embodiments of the present invention, a particular API module 50 is modified to interface with such service application 14 and/or a new/different API module 50 provided for such service application 14. Further, as described above, the modified and/or new API module 50 is mapped to the corresponding service application 14 and service logic module(s) 52.

Additionally, tier 46 of architecture 12 enables adaptability of gateway architecture 12 to new and/or additional network domains 16 without necessitating a change and/or redesign to a respective service logic module 52. For example, in some embodiments of the present invention, to support a new and/or additional network domain 16 and/or a change to a particular network domain 16, a mediation layer module 54 is provided and/or otherwise configured to interface with such network domain 16. In some embodiments of the present invention, a particular mediation layer module 54 is modified to interface with such network domain 16 and/or a new/different mediation layer module 54 is provided for such network domain 16. Further, as described above, the modified and/or new mediation layer module 54 is mapped to the corresponding network domain 16 and service logic module(s) 52.

In FIG. 1, gateway architecture 12 is illustrated as being disposed on and/or otherwise forming part of a single computer system and/or platform 60. However, it should be understood that one or more components of gateway architecture 12 may be formed as a distributed configuration. For example, in some embodiments of the present invention, one or more API modules 50, service logic modules 52 and/or mediation layer modules 54 may reside on different computer systems and/or platforms in a distributed resource environment, thereby facilitating enhanced configurability of telecommunications system 10. For example, in some embodiments of the present invention, a mediation layer module 54 disposed on a particular computer system and/or platform and communicatively coupled and/or mapped to a service logic module 52 residing on another computer system and/or platform and, in turn, such service logic module 52 is communicatively coupled and/or mapped to an API module 50 residing on yet another computer system and/or platform. Thus, embodiments of the present invention facilitate adaptability and/or configurability to accommodate a variety of different types of telecommunications system applications.

Thus, embodiments of the present invention enable a configurable and adaptable telecommunications gateway architecture 12 to facilitate interfacing with a variety of different service applications (14) and/or a variety of different types of network domains 16. For example, embodiments of the present invention provide service logic modules(s) 52 operating and/or otherwise functioning independently of a direct interface to service application(s) 14 and/or network domain(s) 16, thereby facilitating a single service logic module 52 to be interfaced with different types of service applications 14 (e.g., via respective API modules 50) and/or different types of network domains 16 (e.g., via respective mediation layer modules 54).

What is claimed is:

1. A telecommunications system gateway architecture, comprising:
at least one service logic module communicatively coupled to a plurality of mediation layer modules, each respective mediation layer module adapted to interface the at least one service logic module with a respective different network domain.

2. The architecture of claim 1, further comprising an application programming interface (API) module communicatively coupled to the at least one service logic module.

3. The architecture of claim 1, wherein the at least one service logic module is disposed at a layer between the plurality of mediation layer modules and at least one API module.

4. The architecture of claim 1, further comprising a plurality of API modules each communicatively coupled to the at least one service logic module.

5. The architecture of claim 1, further comprising a plurality of API modules each communicatively coupled to the at least one service logic module, the plurality of API modules adapted to interface the at least one service logic module with respectively different service applications.

6. The architecture of claim 1, wherein the at least one service logic module comprises at least two service logic modules each communicatively coupled to each of the plurality of mediation layer modules.

7. The architecture of claim 1, further comprising a service administration module adapted to coordinate mapping of the at least one service logic module to each of the respectively communicatively coupled mediation layer modules.

8. The architecture of claim 1, wherein the at least one service logic module resides on a same platform of at least one of the plurality of mediation layer modules.

9. A method of providing telecommunications services, comprising:
providing a telecommunications service via at least one service logic module of a gateway architecture; and
interfacing the at least one service logic module to a plurality of different network domains via a plurality of respectively communicatively coupled mediation layer modules of the gateway architecture.

10. The method of claim 9, further comprising interfacing the at least one service logic module to a service application.

11. The method of claim 9, further comprising interfacing the at least one service logic module to a plurality of different service applications.

12. The method of claim 9, further comprising interfacing the at least one service logic module to a plurality of different service applications via a plurality of respectively communicatively coupled application programming interface (API) modules of the gateway architecture.

13. The method of claim 9, further comprising mapping the service logic module to each of the respectively communicatively coupled mediation layer modules.

14. The method of claim 9, further comprising mapping the service logic module to a plurality of API modules of the gateway architecture.

15. The method of claim 9, further comprising providing a telecommunications service via at least two service logic modules of the gateway architecture, each of the at least two service logic modules communicatively coupled to each of the plurality of mediation layer modules.

16. A telecommunications system gateway architecture, comprising:
a first tier adapted to interface with a service application;
a second tier having service logic module to facilitate interaction between the service application and a network domain; and
a third tier adapted to interface the service logic with a plurality of different network domains.

17. The architecture of claim 16, wherein the third tier comprises a plurality a mediation layer modules communicatively coupled to the service logic module.

18. The architecture of claim 16, wherein the first tier comprises a plurality of application programming interface (API) modules communicatively coupled to the service logic module.

19. The architecture of claim 16, wherein the first tier is adapted to interface the service logic to a plurality of different service applications.

20. The architecture of claim 16, wherein the first tier comprises a plurality of API modules each adapted to interface the service logic module to a respective different service application.

21. The architecture of claim 16, further comprising a service administration module adapted to map the service logic module to modules residing on the first and third tiers.

22. The architecture of claim 16, further comprising a service administration module adapted to map the service logic module to a plurality of API modules residing on the first tier.

23. The architecture of claim 16, further comprising a service administration module adapted to map the service logic module to a plurality of mediation layer modules residing on the third tier.

24. The architecture of claim 16, wherein the second tier comprises a at least two service logic modules communicatively coupled an API module residing on the first tier.

25. The architecture of claim 16, wherein the second tier comprises a at least two service logic modules communicatively coupled to a mediation layer module residing on the third tier.

26. The architecture of claim 16, wherein the first tier resides on a same platform as the second tier.

27. The architecture of claim 16, wherein the first tier resides on a same platform as the third tier.

28. The architecture of claim 16, wherein the second tier resides on a same platform as the third tier.
